(19) United States
(12) Patent Application Publication
(10) Pub. No.: US 2026/0063463 A1
(43) Pub. Date: Mar. 5, 2026

(54) WEIGHT MEASUREMENT SYSTEM, INFORMATION PROCESSING DEVICE, AND WEIGHT MEASUREMENT METHOD

(71) Applicant: SINTOKOGIO, LTD., Nagoya-shi (JP)

(72) Inventors: Ken NAGAI, Nagoya-shi (JP); Yoshikane TANAAMI, Nagoya-shi (JP)

(73) Assignee: SINTOKOGIO, LTD., Nagoya-shi (JP)

(21) Appl. No.: 19/307,207

(22) Filed: Aug. 22, 2025

(30) Foreign Application Priority Data
Aug. 30, 2024 (JP) 2024-149976
Jan. 10, 2025 (JP) 2025-004367

(51) Int. Cl. G01G 19/03; G01G 19/14; G01G 23/37

(52) U.S. Cl. CPC G01G 19/03; G01G 19/14; G01G 23/3707

(57) ABSTRACT

A weight measurement system includes: a force sensor attachable to a gripping part of a carrying arm carrying an article by gripping; a first obtaining section configured to obtain an output signal from the force sensor when the gripping part that is gripping the article moves three-dimensionally; a weight deriving section configured to derive weight data indicating a weight of the article by processing the output signal; and an output section configured to output the weight data to an external entity.

This Nonprovisional application claims priority under 35 U.S. C. § 119 on Patent Application No. 2025-004367 filed in Japan on Jan. 10, 2025 and Patent Application No. 2024-149976 filed in Japan on Aug. 30, 2024, the entire contents of which are hereby incorporated by reference.

### TECHNICAL FIELD

The present invention relates to a weight measurement system, an information processing device, and a weight measurement method.

### BACKGROUND ART

Methods have been known for measuring a force or weight with use of force sensors. For example, Patent Literature 1 discloses a force sensor device including a force sensor, a load cell using a force sensor device, a robot hand using a force sensor device, and the like.

### CITATION LIST

### Patent Literature

### [Patent Literature 1]

Japanese Patent Application Publication, Tokukai, No. 2023-123902

### SUMMARY OF INVENTION

### Technical Problem

However, with the conventional art as above, a weight of a measurement target is typically measured with the measurement target standing still. There is also a known method for measuring a weight while causing a measurement target to move in a gravitational direction or a horizontal direction, but this method is not practical because of operational constraints and may not provide demanded measurement accuracy. Further, measurement methods using force sensors are typically limited to specific measurement targets, and thus are unfortunately lack versatility.

It is an object of an aspect of the present invention to achieve a versatile weight measurement technology that enables accurate measurement of a weight with use of a force sensor while causing a measurement target to move three-dimensionally and that is applicable to measurement targets having various weights.

### Solution to Problem

In order to solve the foregoing problem, a weight measurement system in accordance with an aspect of the present invention includes: a force sensor attachable to a gripping part of a carrying arm carrying an article by gripping; a first obtaining section configured to obtain an output signal from the force sensor when the gripping part that is gripping the article moves three-dimensionally; a weight deriving section configured to derive weight data indicating a weight of the article by processing the output signal; and an output section configured to output the weight data to an external entity.

An information processing device in accordance with an aspect of the present invention includes: a first obtaining section configured to obtain an output signal, when a gripping part of a carrying arm which part is gripping an article moves three-dimensionally, from a force sensor attached to the gripping part, the carrying arm carrying the article by gripping; a weight deriving section configured to derive weight data indicating a weight of the article by processing the output signal; and an output section configured to output the weight data to an external entity.

A weight measurement method in accordance with an aspect of the present invention includes: a first obtaining step of obtaining an output signal, when a gripping part of a carrying arm which part is gripping an article moves three-dimensionally, from a force sensor attached to the gripping part, the carrying arm carrying the article by gripping; a weight deriving step of deriving weight data indicating a weight of the article by processing the output signal; and an output step of outputting the weight data to an external entity.

The control sections of an information processing device in accordance with each aspect of the present invention may be realized by a computer. In this case, the scope of the present invention encompasses a control program for the information processing device which program realizes the information processing device by the computer by causing the computer to operate as each section (software element) of the control sections, and a computer-readable storage medium in which the control program is stored.

### Advantageous Effects of Invention

According to an aspect of the present invention, it is possible to achieve a versatile weight measurement technology that enables accurate measurement of a weight with use of a force sensor while causing a measurement target to move three-dimensionally and that is applicable to measurement targets having various weights.

### BRIEF DESCRIPTION OF DRAWINGS

FIG. 1 is a block diagram illustrating a configuration of a weight measurement system 1 in accordance with Embodiment 1 of the present invention.

FIG. 2 is a view schematically illustrating one example of a carrying arm in accordance with Embodiment 1.

FIG. 3 is an example plan view schematically illustrating a site in which the carrying arm in accordance with Embodiment 1 is carrying an article as viewed from above.

FIG. 4 is a flowchart illustrating a flow of a weight measurement method S1 in accordance with Embodiment 1.

FIG. 5 is a block diagram illustrating a configuration of a weight measurement system 1A in accordance with Embodiment 2.

FIG. 6 is a flowchart illustrating a flow of a weight measurement method S2 in accordance with Embodiment 2.

### DESCRIPTION OF EMBODIMENTS

Embodiment 1

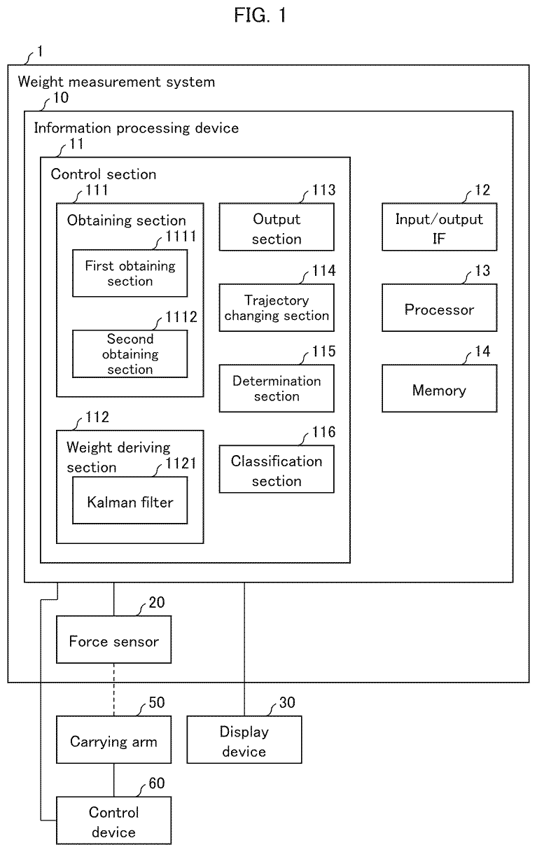

The following description will discuss an embodiment of the present invention in detail. FIG. 1 is a block diagram illustrating a configuration of a weight measurement system 1 in accordance with Embodiment 1. The weight measurement system 1 in accordance with the present embodiment is a system that is combined with a specific carrying arm to be able to measure a weight of an article gripped by the carrying arm. As illustrated in the drawing, the weight measurement system 1 includes an information processing device 10 and a force sensor 20 attachable to a carrying arm 50. The information processing device 10 includes a control section 11, an input/output IF (interface) 12, at least one processor 13, and at least one memory 14. The information processing device 10 obtains and processes an output signal from the force sensor 20 and acceleration data of the carrying arm 50 to output weight data of the article gripped by the carrying arm 50.

The force sensor 20 is attached to the carrying arm 50. The carrying arm 50 is a robotic arm capable of gripping and moving an article or an equivalent mechanical device. In the example illustrated in FIG. 1, the carrying arm 50 is not included in the weight measurement system 1, but the carrying arm 50 may be included in the weight measurement system 1. The force sensor 20 may communicate with the information processing device 10 according to the serial communication standard RS-422.

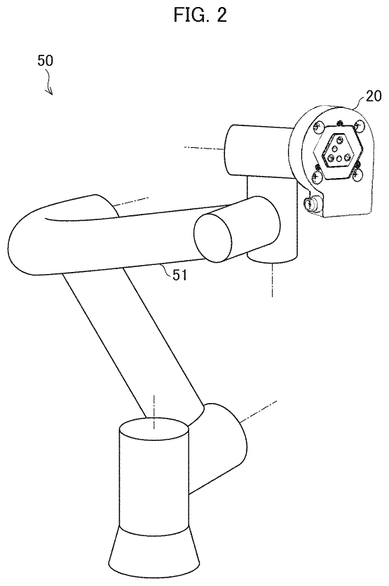

FIG. 2 is a view schematically illustrating one example of the carrying arm 50. FIG. 2 illustrates a plurality of arm parts 51 coupled to each other and having rotation shafts shown by the dashed dotted lines, and the force sensor 20 mounted at an end part of the arm parts 51. Note that FIG. 2 does not illustrate a gripping part (hand part) for gripping the article, which is typically mounted at the end part of the arm parts 51. The force sensor 20 may be attached between the end part of the arm parts 51 and the gripping part. The gripping part may, for example, include a plurality of finger parts (claw parts) and be configured to be able to grip the article with use of the finger parts. Alternatively, the gripping part may grip the article with use of a specific gripping means.

The carrying arm 50 is controlled by a control device 60. The carrying arm 50 may be configured such that the gripping part thereof can be replaced. The carrying arm 50 may be, for example, a multi-axis robot having a plurality of arm parts 51 that rotate, as described above. Alternatively, the carrying arm 50 may be an articulated robot having a plurality of joints. The carrying arm 50 may be, for example, an arm in a manufacturing factory that carries a product manufactured in the factory. The weight measurement system 1 can measure a weight of an article while the carrying arm 50 is carrying the article. The carrying arm 50 may be an arm that sorts and carries articles such as agricultural products or various raw materials in addition to factory products. The load that can be carried by the carrying arm 50 may be set as appropriate.

The carrying arm 50 may include an acceleration sensor (not illustrated). In this case, the acceleration sensor may be attached to, for example, the end part or the gripping part of the carrying arm 50. Alternatively, an encoder may be attached to a motor of the carrying arm 50 to detect a rotation angle instead of or in addition to the acceleration sensor. It is possible to derive an acceleration occurring in the gripping part of the carrying arm 50 with use of an output signal from the acceleration sensor or an output signal from the encoder.

The force sensor 20 is attachable to the carrying arm 50 carrying an article. A position to which the force sensor 20 is attached may lie, for example, between the gripping part and the arm parts 51 of the carrying arm 50. This makes it possible to detect a force applied to the article gripped by the gripping part. The force sensor 20 is, for example, a six-axis force sensor which can detect and output magnitudes of forces in axial directions of X-, Y-, and Z-axes (including positive and negative directions) and magnitudes of rotation moments about the X-, Y-, and Z-axes (including positive and negative directions). Note, however, that the type of the force sensor 20 is not limited to this. The measurement capability (measurable range) of the force sensor 20 can be selected as appropriate in accordance with the carrying arm 50 to be attached.

The following will describe the information processing device 10. The control section 11 of the information processing device 10 includes an obtaining section 111, a weight deriving section 112, and an output section 113. The control section 11 may include a trajectory changing section 114, may include a determination section 115 as well, and may include a classification section 116 as well.

The obtaining section 111 includes a first obtaining section 1111 and a second obtaining section 1112. The first obtaining section 1111 obtains an output signal from the force sensor 20 when the carrying arm 50 that is gripping an article moves three-dimensionally. The expression “three-dimensional (three-dimensionally)” includes directions obtained by combining all of the X-, Y-, and Z-axes with the gravitational direction regarded as the Z-axis and includes oblique directions, not only the horizontal direction (X-axis and Y-axis directions) or the gravitational direction (Z-axis direction). The carrying arm 50 is controlled to cause the article to move three-dimensionally along a predetermined trajectory after gripping the article. That is, the carrying arm 50 can move freely not only in the horizontal direction or the gravitational direction but also in oblique directions. Further, the trajectory is not limited to a straight line, and may be curvilinear motion. The trajectory is stored in the control device 60 as a control program. The force sensor 20 outputs a signal according to a strain of a strain element occurring in the movement. This output signal is transmitted to the information processing device 10. The first obtaining section 1111 obtains this output signal via the input/output IF 12.

The second obtaining section 1112 obtains acceleration data of the carrying arm 50 when the carrying arm 50 that is gripping an article moves three-dimensionally. In particular, the second obtaining section 1112 obtains the acceleration data of the gripping part of the carrying arm 50. The second obtaining section 1112 may obtain the acceleration data by any method. For example, in a case where the carrying arm 50 includes the acceleration sensor or the encoder described above, the second obtaining section 1112 can obtain the acceleration data by obtaining an output signal from the acceleration sensor or the encoder and performing a given computation. Alternatively, the second obtaining section 1112 may obtain, from the control device 60, for example, rotation speed data of the rotation shafts of the carrying arm 50 which is included in the control program to calculate the acceleration data of the gripping part. The obtaining section 111 inputs, to the weight deriving section 112, the output signal obtained by the first obtaining section 1111 and the acceleration data obtained by the second obtaining section 1112.

The weight deriving section 112 derives weight data indicating a weight of the article by processing the inputted output signal and acceleration data. Strictly speaking, the weight derived from the equation of motion is a mass. However, since a weight can be calculated by multiplying the gravitational acceleration, it is hereinafter referred to as “weight data” or simply “weight” after the calculation rather than the “mass”. This configuration makes it possible to derive a weight even while the article is moving three-dimensionally. That is, it is possible to measure a weight during carrying operation. Therefore, a weight measuring step consisting only of measuring a weight which has been needed in the conventional art can be omitted, thereby resulting in more efficient operation.

The weight deriving section 112 may include a (extended) Kalman filter 1121. The “Kalman filter” is a computation filter for combining a result of solving the equation of motion such as the laws of physics with a measurement value obtained from, for example, a sensor to more accurately predict a specific physical quantity in order to know a true value of the specific physical quantity. Depending on the accuracy of the force sensor 20 and the acceleration sensor, it may be impossible to accurately derive a weight through single measurement. The weight can be derived with use of a more accurate acceleration or speed by inputting output signals from the force sensor 20 and the acceleration sensor to the (extended) Kalman filter 1121 and sequentially processing the plurality of output signals and pieces of acceleration data that are arranged in time order. This configuration makes it possible to more accurately derive a weight. Therefore, it is possible to accurately derive a weight, even while the article is moving three-dimensionally.

The output section 113 outputs the weight data derived by the weight deriving section 112 to an external entity via the input/output IF 12. The “external entity” refers to an entity external to the weight measurement system 1. For example, the output section 113 may output the weight data to the control device 60 of the carrying arm 50. The control device 60 may be configured to refer to the inputted weight to control the carrying arm 50. The output section 113 may generate display data for being displayed on an external display device 30 and output the data to the display device 30.

In a case where the carrying arm 50 is controlled by process management equipment (e.g., a process management computer) of, for example, a manufacture factory, the output section 113 may output the weight data to the process management equipment. The process management equipment may be configured to refer to the inputted weight to control the carrying arm 50. The following description will discuss a case where the carrying arm 50 is controlled by the control device 60, but the same description applies to the case where the carrying arm 50 is controlled by the process management equipment.

The weight measurement system 1 may refer to the weight derived by the weight deriving section 112 to select a control signal for the carrying arm 50 and output the control signal to the control device 60. In this case, the control device 60 uses the control signal received from the weight measurement system 1 to control the carrying arm 50. The following will describe such an example.

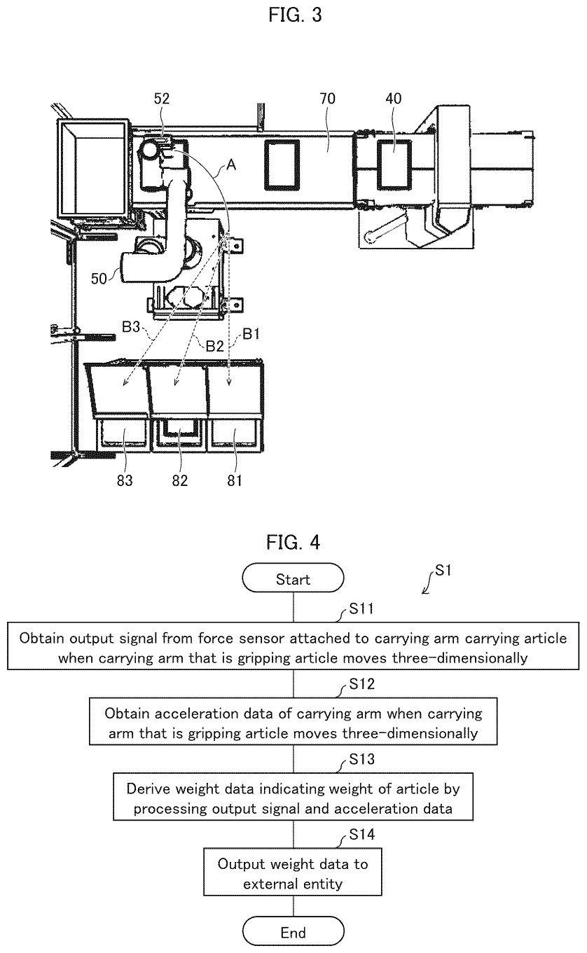

The weight measurement system 1 may include the trajectory changing section 114. The trajectory changing section 114 refers to the weight data to change a trajectory along which the gripping part of the carrying arm 50 moves. In other words, the trajectory changing section 114 refers to the weight data to change a destination of the gripped article. The following will describe this with reference to FIG. 3. FIG. 3 is an example plan view schematically illustrating a site in which the carrying arm 50 is carrying the article as viewed from above. In FIG. 3, articles 40 are conveyed by the conveyor 70 sequentially in a left direction from the upper right in the drawing and reach the front of the carrying arm 50 shown in the upper left. The carrying arm 50 carries an article 40 to any one of the destinations 81, 82, and 83 shown in a lower part of the drawing. The following will describe the process.

The carrying arm 50 detects an article 40 from, for example, an image captured by a camera (not illustrated) and grips the article 40 with use of a gripping part 52 thereof. Afterwards, the carrying arm 50 causes the gripping part 52 to move along a predetermined trajectory A while gripping the article 40. While the gripping part 52 is being caused to move along the trajectory A, the output signal from the force sensor 20 and acceleration data are processed by the weight deriving section 112 of the information processing device 10 and are outputted as a weight. The trajectory changing section 114 obtains this weight and changes (selects) a trajectory along which the gripping part 52 is caused to move, in accordance with a class of the weight. The trajectory changing section 114 then outputs data on the selected trajectory to the control device 60 of the carrying arm 50. The trajectory data may be a program or may be a trajectory number. The control device 60 controls the carrying arm 50 with reference to the trajectory data received.

In the example illustrated in FIG. 3, the weight class of the article 40 is divided in advance into three classes: a first class, a second class, and a third class. When the weight of the article 40 corresponds to the first class, the trajectory changing section 114 changes a trajectory following the trajectory A to a trajectory B1, that is, selects the trajectory B1 as the trajectory following the trajectory A. The output section 113 then outputs, to the control device 60, trajectory data indicating the trajectory B1 after the change. The expression “change” may refer to selection of any one of the predetermined trajectories B1, B2, and B3. The output section 113 may output a signal indicating the trajectory B1 as trajectory data to the control device 60. The control device 60 may include a control program unit that implements the trajectory B1 and may control the carrying arm 50 with use of the program.

Similarly, in a case where the weight of the article 40 corresponds to the second class, the trajectory changing section 114 changes the trajectory following the trajectory A to the trajectory B2. In a case where the weight of the article 40 corresponds to the third class, the trajectory changing section 114 changes the trajectory following the trajectory A to the trajectory B3. The changed contents are outputted to the control device 60. The gripping part 52 then releases the article 40 at the end point of each trajectory, so that the article 40 is carried to the corresponding one of the given destinations 81, 82, and 83.

In the example illustrated in FIG. 3, the weight of the article 40 is divided into three classes with which the destination 81, 82, or 83 is determined. However, the method for changing the destination in accordance with the weight is not limited to this. For example, in a case where an article 40 whose weight falls within a given range is regarded as an acceptable product, an acceptable product may be carried to a given packaging container, and a rejected product may be carried to a rejected-product storage area. The obtaining section 111 may count the number of the articles 40 regarded as acceptable products. It is also possible that when a given number of acceptable products are collected, the obtaining section 111 communicates with the process management equipment so that the process management equipment performs control to cause the packaging container to move to a shipment space.

The obtaining section 111 may further obtain the type of the article 40. The trajectory changing section 114 may refer to the type of the article 40 to change the trajectory along which the gripping part 52 of the carrying arm 50 moves. For example, the obtaining section 111 may obtain the type of the article 40 through image analysis using an image of the article 40 captured by a camera or the like (not illustrated). The obtaining section 111 may include a machine model that has learned images of several types of articles in advance, and identify the type of the article 40 with use of the machine model. According to this configuration, it is possible to change the destination (carrying position) considering not only the weight of the article 40 but also the type of the article 40.

The weight measurement system 1 may include the determination section 115. The determination section 115 determines whether or not the weight data satisfies a predetermined weight standard. The weight standard specifies, for example, whether or not a weight of an article 40, such as a product or an agricultural product, is equal to or less than a specific weight, or whether or not the weight is equal to or greater than a specific weight, or whether or not the weight falls between a specific weight and a specific weight, or the like. For example, the weight standard may be obtained from the process management equipment by the obtaining section 111, and it is alternatively possible to obtain a weight standard inputted by a user through an input section of the information processing device 10. The trajectory changing section 114 may refer to a determination result from the determination section 115 to change the trajectory of the gripping part 52. Such a configuration makes it possible to determine, for example, acceptance or rejection according to the weight standard and carry the article 40 to a given destination in accordance with the determination result with use of the trajectory changing section 114.

The weight measurement system 1 may include the classification section 116. The classification section 116 classifies the type of the article 40 with reference to the weight data. For example, in a case where a plurality of types of articles 40 are conveyed, each article 40 is gripped to measure the weight thereof, and the classification section 116 classifies the type of the article 40 by the weight. The trajectory changing section 114 may refer to a classification result from the classification section 116 to change the trajectory of the gripping part 52. Such a configuration makes it possible to classify the type of the article 40 by the weight and carry the article 40 to a given destination in accordance with the classification result with use of the trajectory changing section 114.

The input/output IF 12 of the information processing device 10 is an interface which outputs information to an external entity or which obtains information (to which information is inputted) form an external entity. The input/output IF 12 may be, for example, a wireless communication unit such as Wi-Fi (registered trademark) or Bluetooth (registered trademark), or a wired communication unit such as a USB input/output terminal.

The processor 13 can be configured, for example, with use of at least one general-purpose processor, such as a micro processing unit (MPU) or a central processing unit (CPU). The processor 13 may include a dedicated processor configured with, for example, an application specific integrated circuit (ASIC), a field programmable gate array (FPGA), or a programmable logic device (PLD).

The memory 14 may include a plurality of types of memories, such as a read only memory (ROM) and a random access memory (RAM). Further, the memory 14 may include a built-in or external memory, such as a hard disk drive (HDD) or a solid state drive (SDD). As an example, the control section 11 implements functions as the obtaining section 111, the weight deriving section 112, the output section 113, the trajectory changing section 114, the determination section 115, and the classification section 116 by loading various control programs stored in the ROM of the memory 14 on the RAM and executing them. The memory 14 may store at least one of the weight data, the trajectory data after change by the trajectory changing section 114, the determination result from the determination section 115, and the classification result from the classification section 116.

The memory 14 may store various programs. For example, the memory 14 may store a custom program corresponding to the environment under which the weight measurement system 1 is used, such as a trajectory program for causing the article 40 to move to a carrying position corresponding to a site in which the carrying arm 50 operates, a program for determining or classifying weight data by a threshold, or a data processing program corresponding to the type of the force sensor 20. The output section 113 may output, for example, data stored in the memory 14 to the display device 30.

The above program can be created with use of commonly used programming languages. Examples of the programming languages include C#, C++, and Python. By using these programming languages, it is possible to enhance the compatibility with the control program used in the control device 60 of the carrying arm 50 to facilitate connection to the control device 60 of the existing carrying arm 50. These languages can also be used in robot development platforms, such as ROS and ROS2, and thus have an advantage of high compatibility with the carrying arm 50 developed with use of such a platform.

To the weight measurement system 1, a specific display device 30 may be connected. The display device 30 may display at least one of the measured weight data, the trajectory data after change by the trajectory changing section 114, the determination result from the determination section 115, and the classification result from the classification section 116 which are stored in the memory 14. The display device 30 may be a display of a personal computer to which the information processing device 10 is incorporated. The memory 14 may be a memory of the personal computer. The threshold and the like may be configured to be able to be inputted as appropriate by a user via the display device 30.

The weight measurement system 1 having the above configurations makes it possible to achieve a versatile weight measurement technology that enables accurate measurement of a weight with use of the force sensor 20 while causing the measurement target to move three-dimensionally and that is applicable to measurement targets having various weights by selecting the force sensor 20 as appropriate in accordance with the capacity of the carrying arm 50. Further, it is possible to control movement of the carrying arm 50 on the basis of the weight measured, for example.

The following description will discuss a weight measurement method S1 in accordance with the present embodiment. FIG. 4 is a flowchart illustrating a flow of the weight measurement method S1 in accordance with the present embodiment. As illustrated in the drawing, the weight measurement method S1 includes steps S11 to S14.

The step S11 is a first obtaining step of obtaining an output signal, when the carrying arm 50 carrying the article 40 that is gripping the article 40 moves three dimensionally, from the force sensor 20 attached to the carrying arm 50. The first obtaining step S11 is performed by the first obtaining section 1111 described above.

The step S12 is a second obtaining step of obtaining acceleration data of the carrying arm 50 when the carrying arm 50 that is gripping the article 40 moves three-dimensionally. The second obtaining step S12 is performed by the second obtaining section 1112 described above.

The step S13 is a deriving step of deriving weight data indicating a weight of the article 40 by processing the output signal from the force sensor 20 and the acceleration data calculated with use of the acceleration sensor or the encoder. The deriving step S13 is performed by the weight deriving section 112 described above.

The step S14 is an output step of outputting the weight data to an external entity. The output step S14 is performed by the output section 113 described above. In the output step S14, the weight data may be outputted to the control device 60 of the carrying arm 50.

The weight measurement method S1 may further include a trajectory change step of referring to the weight data to change a trajectory along which the gripping part 52 of the carrying arm 50 moves. In this case, in the output step S14, the trajectory data indicating the trajectory after the change may be outputted to the control device 60 of the carrying arm 50.

Further, the weight measurement method S1 may involve, in the trajectory change step, referring to the type of the article 40 to change the trajectory along which the gripping part 52 of the carrying arm 50 moves. In this case, in the first obtaining step S11, the type of the article 40 may be obtained.

The weight measurement method S1 may further include a determination step of determining whether or not the weight data satisfies a predetermined weight standard. In this case, in the trajectory change step, the trajectory may be changed with reference to the determination result of the determination step.

The weight measurement method S1 may further include a classification step of classifying the article 40 with reference to the weight data. In this case, in the trajectory change step, the trajectory may be changed with reference to the classification result of the classification step.

The weight measurement method S1 above makes it possible to achieve a versatile weight measurement technology that enables accurate measurement of a weight with use of the force sensor 20 while causing the measurement target to move three-dimensionally and that is applicable to measurement targets having various weights by selecting the force sensor 20 as appropriate in accordance with the capacity of the carrying arm 50. Further, it is possible to control movement of the carrying arm 50 on the basis of the weight measured, for example.

### Embodiment 2

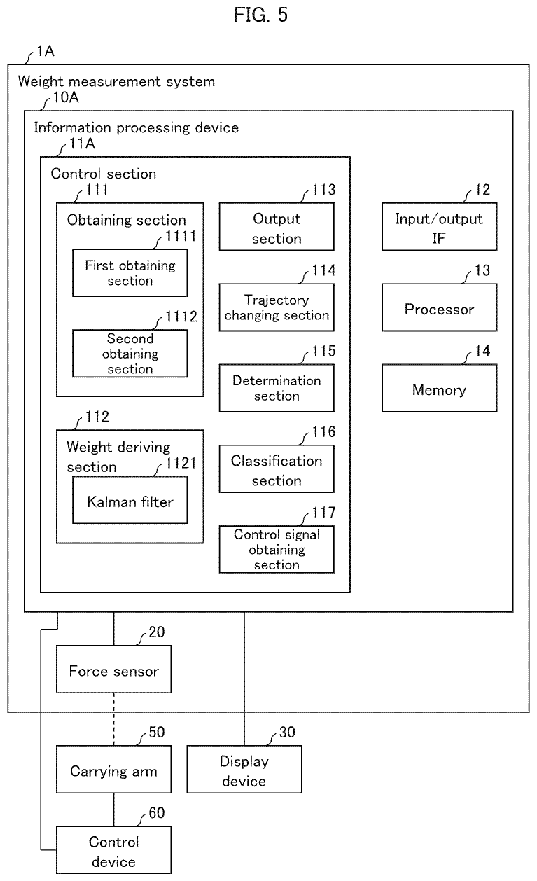

The following description will discuss Embodiment 2 of the present invention with reference to the drawings. FIG. 5 is a block diagram illustrating a configuration of the weight measurement system 1A in accordance with Embodiment 2. The following description will mainly discuss features different from the configuration of Embodiment 1, and the same functions as those of the sections described in Embodiment 1 are not described here. The weight measurement system 1A in accordance with Embodiment 2 is a system that measures a weight of a gripped article by processing an output signal from the force sensor 20 solely. That is, it is not essential to include a second obtaining section configured to obtain acceleration data from an acceleration sensor and the like which is described in Embodiment 1. However, when the second obtaining section configured to obtain acceleration data is included, it is possible to more accurately measure a weight. In this case, the force sensor 20 is attached to the gripping part 52 (see FIG. 3). More specifically, the force sensor 20 is attached between an end part of the arm parts 51 and the gripping part 52. That is, the force sensor 20 is configured to directly receive a weight of the article gripped by the gripping part 52 and output a sensor signal to the information processing device 10.

As illustrated in FIG. 5, a control section 11A of an information processing device 10A of the weight measurement system 1A includes a control signal obtaining section 117. The control signal obtaining section 117 will be described later. The configurations of the weight measurement system 1A other than this are the same as those of the weight measurement system 1 in accordance with Embodiment 1.

As in Embodiment 1, the gripping part 52 is controlled to move three-dimensionally. The gripping part 52 may be controlled to move in any three-dimensional manner. However, in a case where an output signal from the force sensor 20 is solely used to measure a weight of an article, it is expected that a fixed movement of the gripping part 52 according to a specific condition leads to further improved weight measurement accuracy. For example, the arm parts 51 may be controlled so that the gripping part 52 moves along a predetermined trajectory. Alternatively, the arm parts 51 may be controlled so that the gripping part 52 moves with a predetermined acceleration.

The weight deriving section 112 may derive weight data of a gripped article by, for example, processing an output signal from the force sensor 20 for a case where the gripping part 52 is controlled to move along a predetermined trajectory. This case includes a case where the gripping part 52 is controlled to move along a predetermined trajectory and with a predetermined acceleration.

In this case, the weight deriving section 112 may derive the weight data with reference to a correlation between an output signal from the force sensor for a case where the gripping part 52 is controlled to move along a predetermined trajectory which signal is obtained when a specific article is carried and weight data corresponding to the output signal. This correlation may be set up by performing carrying tests with various patterns in advance. For example, articles having various shapes and various weights are caused to move along a predetermined trajectory to obtain output signals from the force sensor 20. Then, much data on what output signal is obtained from movement of an article having what weight and what shape along a predetermined trajectory is obtained. A formula is set up to which a given output signal is substituted to calculate weight data of an article under each of various carrying conditions. The formula thus obtained is one type of the correlation. The formula may be, for example, a formula using a linear model, a formula using a quadratic function model, or a formula using a polynomial model.

Alternatively, a reference table may be created which lists a combination of a carrying condition and an output signal and the weight data corresponding to the combination under each of various carrying conditions. Examples of the carrying conditions include a trajectory along which the gripping part moves and an acceleration with which the gripping part moves. Such a reference table is also one type of the correlation.

Alternatively, the correlation (or formula) may be set up with use of a machine model. For example, it is also possible that much actual measurement data (learning data) in which a given carrying condition including a predetermined trajectory and the like, an output signal actually measured at that time, and weight data are combined is collected, and this learning data is used to subject a machine model to learning for inferring weight data of an article. The inferred weight data is outputted by inputting an output signal at that time to the machine model subjected to learning for each carrying condition. An algorithm including parameters contained in the learned machine model is also considered a formula. The correlation described above may be stored in, for example, the memory 14 or an external database or memory.

In a case where the weight deriving section 112 derives weight data of an article for a case where the gripping part 52 is controlled to move along a predetermined trajectory and with a predetermined acceleration, for example, a formula may be set up to which a given output signal is substituted under a carrying condition of a predetermined trajectory and acceleration to calculate weight data of the article. Further, it is understood as describe above that a reference table or a machine model may be used as a correlation instead of the formula.

The weight deriving section 112 may derive weight data of a gripped article by, for example, processing an output signal from the force sensor 20 for a case where the gripping part 52 is controlled to move with a predetermined acceleration. This case includes a case where the gripping part 52 is controlled to move with a predetermined acceleration and along a predetermined trajectory.

Also in this case, the weight deriving section 112 may derive the weight data with reference to, for example, a correlation between a weight of a specific article as measured in a case where the gripping part 52 is controlled to move with a predetermined acceleration and an output signal corresponding to the article. This correlation may be set up by performing carrying tests in various patterns in advance. For example, articles having various shapes and various weights are caused to move with a predetermined acceleration to obtain output signals from the force sensor 20. In a case where the direction of the acceleration changes, the condition may be included. Then, much data on what output signal is obtained from movement of an article having what weight and what shape with what acceleration is obtained. A formula is set up to which a given output signal is substituted to calculate weight data of an article under each of various carrying conditions. The formula thus obtained is one type of the correlation. The formula may be, for example, a formula using a linear model, a formula using a quadratic function model, or a formula using a polynomial model.

A reference table may be created which lists a combination of a carrying condition and an output signal and the weight data corresponding to the combination under each of various carrying conditions. Examples of the carrying conditions include one or both of an acceleration and a direction of the acceleration of the gripping part and a trajectory along which the gripping part moves. Such a reference table is also one type of the correlation.

Alternatively, the correlation (or formula) may be set up with use of a machine model. For example, it is possible that much actual measurement data (learning data) in which a given carrying condition including a predetermined acceleration and the like, an output signal actually measured at that time, and weight data are combined is collected, and this learning data is used to subject a machine model to learning for inferring weight data of the article. The inferred weight data is outputted by inputting an output signal at that time to the machine model subjected to learning for each carrying condition. An algorithm including parameters contained in the learned machine model is also considered a formula. The correlation described above may be stored in, for example, the memory 14 or an external memory.

In a case where the weight deriving section 112 derives weight data of an article for a case where the gripping part 52 is controlled to move with a predetermined acceleration and along a predetermined trajectory, for example, a formula may be set up to which a given output signal is substituted under carrying conditions of a predetermined acceleration and trajectory to calculate weight data of an article. Further, it is understood as describe above that a reference table or a machine model may be used as a correlation instead of the formula.

The weight deriving section 112 may derive the weight data with use of one or more of the correlations (formulas) described above. That is, the correlation used by the weight deriving section 112 may be at least one of a formula using a linear model, a formula using a quadratic function model, a formula using a polynomial model, and a formula obtained with use of machine learning.

The weight measurement system 1A may include the control signal obtaining section 117. The control signal obtaining section 117 obtains a control signal for controlling the gripping part 52 to move. This control signal is the signal transmitted by the control device 60 to the carrying arm 50 which is described in Embodiment 1. The control signal obtaining section 117 may obtain this signal. The control signal obtaining section 117 notifies the first obtaining section 1111 that this control signal has been obtained. Upon receipt of this notification, the first obtaining section 1111 obtains an output signal from the force sensor 20 after the time point of the receipt. The first obtaining section 1111 then transmits the obtained output signal to the weight deriving section 112. The weight deriving section 112 derives the weight data by processing the output signal from the force sensor 20 subsequent to the time point when the control signal has been obtained. This configuration enables the weight deriving section 112 to efficiently start data processing.

In this case, the control signal may include a specifying signal that specifies what control is performed. The specifying signal may be, for example, a specifying signal indicating a control signal that controls the gripping part 52 to move along a predetermined trajectory or a specifying signal indicating a control signal that controls the gripping part 52 to move with a predetermined acceleration. The specifying signal may be a specifying signal indicating which carrying condition in the reference table described above is used to perform the control, such as the type of the carrying condition. The control signal obtaining section 117 transmits the specifying signal to the weight deriving section 112. By referring to the specifying signal, the weight deriving section 112 can easily determine which method is used to derive the weight. This leads to prompt data processing.

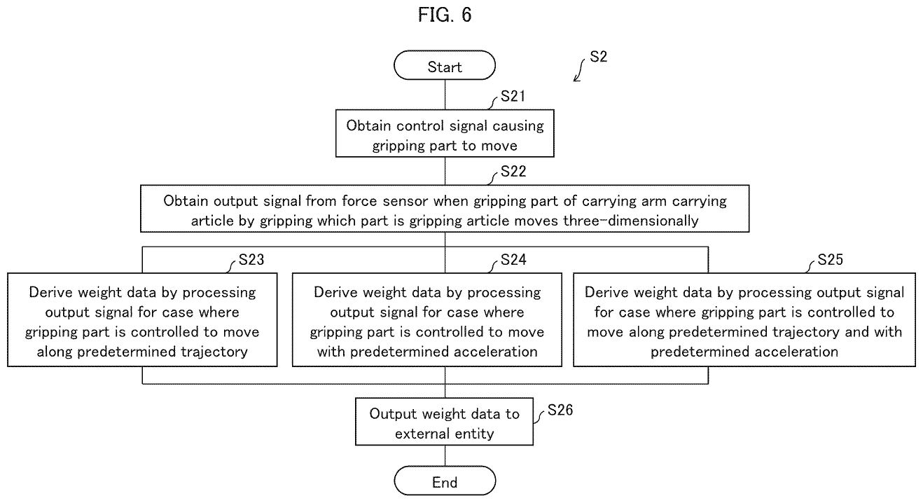

With reference to the drawing, the following description will discuss a weight measurement method S2 performed with use of the weight measurement system 1A. FIG. 6 is a flowchart illustrating a flow of the weight measurement method S2. As illustrated in the drawing, the weight measurement method S2 includes steps S21 to S26.

The step S21 is an obtaining step of obtaining a control signal with which the control signal obtaining section 117 causes the gripping part 52 to move. The step S22 is a first obtaining step of the first obtaining section 1111 obtaining an output signal, when the gripping part 52 of the carrying arm 50 carrying an article by gripping which part is gripping the article moves three-dimensionally, from the force sensor 20 attached to the gripping part 52. Next, the weight deriving section 112 performs a weight deriving step of deriving weight data indicating a weight of an article by processing the output signal, but a way that the weight deriving step is performed differs depending on a pattern in which the gripping part 52 moves. The pattern in which the gripping part 52 moves three-dimensionally while gripping an article includes a plurality of patterns, e.g., a pattern of moving three-dimensionally along a predetermined trajectory and a pattern of moving three-dimensionally with a predetermined acceleration.

The step S23 is a weight deriving step for a case where the gripping part 52 is controlled to move three-dimensionally along a predetermined trajectory. That is, the step S23 is a deriving step of the weight deriving section 112 deriving weight data of an article by obtaining an output signal from the force sensor 20 when the gripping part 52 moves along a predetermined trajectory and processing the output signal.

The step S24 is a weight deriving step for a case where the gripping part 52 is controlled to move three-dimensionally with a predetermined acceleration. That is, the step S24 is a deriving step of the weight deriving section 112 deriving weight data of an article by obtaining an output signal from the force sensor 20 when the gripping part 52 moves three-dimensionally with a predetermined acceleration and processing the output signal.

The step S25 is a weight deriving step for a case where the gripping part 52 is controlled to move three-dimensionally along a predetermined trajectory and with a predetermined acceleration. That is, the step S25 is a deriving step of the weight deriving section 112 deriving weight data of an article by obtaining an output signal from the force sensor 20 when the gripping part 52 moves three-dimensionally along a predetermined trajectory and with a predetermined acceleration and processing the output signal.

The step S26 is an output step of the output section 113 outputting the weight data derived by the weight deriving section 112 to an external entity.

However, it is not necessary to perform all of the steps. For example, the step S21 may not be performed. Selected one of the steps S23 to S25 may be performed.

According to the weight measurement system 1A or the weight measurement method S2 described above, it is possible to accurately measure a weight with use of the force sensor 20 while causing the measurement target to move three-dimensionally. Further, it is possible to achieve a versatile weight measurement technology that is applicable to measurement targets having various weights by selecting the force sensor 20 as appropriate in accordance with the capacity of the carrying arm 50.

### [Software Implementation Example]

Functions of each of the information processing device 10 and 10A (hereinafter referred to as a “device”) can be realized by a program for causing a computer to function as the device, the program causing the computer to function as control blocks (in particular, sections of the control section 11 or 11A) of the device.

In this case, the device includes, as hardware for executing the program, a computer including at least one control device (e.g., a processor) and at least one storage device (e.g., a memory). The functions described in the above embodiments are realized by the program being executed by the at least one control device and the at least one storage device.

The program may be stored in one or more non-transitory computer-readable storage media. The storage media may be included in the device or may not be included in the device. In the latter case, the program may be supplied to the device via any wired or wireless transmission medium.

Furthermore, some or all of functions of the control blocks can also be realized by a logic circuit. For example, the present invention encompasses, in its scope, an integrated circuit in which a logic circuit that functions as each of the above-described control blocks is formed. In addition, the function of each of the control blocks can be realized by, for example, a quantum computer.

Aspects of the present invention can also be expressed as follows:
(Aspect 1)

A weight measurement system including: a force sensor attachable to a carrying arm carrying an article; a first obtaining section configured to obtain an output signal from the force sensor when the carrying arm that is gripping the article moves three-dimensionally; a second obtaining section configured to obtain acceleration data of the carrying arm when the carrying arm that is gripping the article moves three-dimensionally; a weight deriving section configured to derive weight data indicating a weight of the article by processing the output signal and the acceleration data; and an output section configured to output the weight data to an external entity.

According to the above configuration, it is possible to achieve a versatile weight measurement technology that enables accurate measurement of a weight with use of a force sensor while causing a measurement target to move three-dimensionally and that is applicable to measurement targets having various weights.
(Aspect 2)

The weight measurement system according to Aspect 1, wherein the output section outputs the weight data to a control device of the carrying arm.

According to the above configuration, it is possible to refer to the weight data to control the carrying arm.
(Aspect 3)

The weight measurement system according to Aspect 1 or 2, further including a trajectory changing section configured to refer to the weight data to change a trajectory along which a gripping part of the carrying arm moves, the output section outputting trajectory data indicating the trajectory after change to the control device of the carrying arm.

According to the above configuration, it is possible to refer to the weight data to change the trajectory of the carrying arm.
(Aspect 4) The weight measurement system according to Aspect 3, wherein the first obtaining section further obtains the type of the article, and the trajectory changing section refers to the type of the article to change the trajectory along which the gripping part of the carrying arm moves.

According to the above configuration, it is possible to refer to the type of the article and the weight data to change the trajectory of the carrying arm.
(Aspect 5)

The weight measurement system according to Aspect 3, further including a determination section configured to determine whether or not the weight data satisfies a predetermined weight standard, the trajectory changing section changing the trajectory with reference to a determination result from the determination section.

According to the above configuration, it is possible to change the trajectory of the carrying arm on the basis of whether or not the weight standard for the article is satisfied.
(aspect 6)

The weight measurement system according to any one of Aspects 3 to 5, wherein the output section outputs, to a display device, at least one of the weight data, the trajectory after change, and the determination result from the determination section.

The above configuration enables a user to view operation of the weight measurement system.
(Aspect 7)

An information processing device including: a first obtaining section configured to obtain an output signal, when a carrying arm that is gripping an article moves three-dimensionally, from a force sensor attached to the carrying arm, the carrying arm carrying the article; a second obtaining section configured to obtain acceleration data of the carrying arm when the carrying arm that is gripping the article moves three-dimensionally; a weight deriving section configured to derive weight data indicating a weight of the article by processing the output signal and the acceleration data; and an output section configured to output the weight data to an external entity.

According to the above configuration, it is possible to achieve a versatile weight measurement technology that enables accurate measurement of a weight with use of a force sensor while causing a measurement target to move three-dimensionally and that is applicable to measurement targets having various weights.
(Aspect 8)

A weight measurement method including: a first obtaining step of obtaining an output signal, when a carrying arm that is gripping an article moves three-dimensionally, from a force sensor attached to the carrying arm, the carrying arm carrying the article; a second obtaining step of obtaining acceleration data of the carrying arm when the carrying arm that is gripping the article moves three-dimensionally; a weight deriving step of deriving weight data indicating a weight of the article by processing the output signal and the acceleration data; and an output step of outputting the weight data to an external entity.

According to the above configuration, it is possible to achieve a versatile weight measurement technology that enables accurate measurement of a weight with use of a force sensor while causing a measurement target to move three-dimensionally and that is applicable to measurement targets having various weights.
(Aspect 9)

A weight measurement system including:
a force sensor attachable to a gripping part of a carrying arm carrying an article by gripping;
a first obtaining section configured to obtain an output signal from the force sensor when the gripping part that is gripping the article moves three-dimensionally;
a weight deriving section configured to derive weight data indicating a weight of the article by processing the output signal; and
an output section configured to output the weight data to an external entity.
(Aspect 10)

The weight measurement system according to Aspect 9, wherein the weight deriving section derives the weight data by processing the output signal for a case where the gripping part is controlled to move along a predetermined trajectory.
(Aspect 11)

The weight measurement system according to Aspect 9, wherein the weight deriving section derives the weight data by processing the output signal for a case where the gripping part is controlled to move with a predetermined acceleration.
(Aspect 12)

The weight measurement system according to Aspect 10, wherein the weight deriving section derives the weight data with reference to a correlation set up in advance between an output signal from the force sensor for a case where the gripping part is controlled to move along a predetermined trajectory which signal is obtained when a specific article is carried and weight data corresponding to the output signal.
(Aspect 13)

The weight measurement system according to Aspect 11, wherein the weight deriving section derives the weight data with reference to a correlation set up in advance between an output signal from the force sensor for a case where the gripping part is controlled to move with a predetermined acceleration which signal is obtained when a specific article is carried and weight data corresponding to the output signal.
(Aspect 14)

The weight measurement system according to any one of Aspects 9 to 13, further including a control signal obtaining section configured to obtain a control signal that controls the gripping part to move, the weight deriving section deriving the weight data by processing the output signal subsequent to a time point when the control signal has been obtained.
(Aspect 15)

The weight measurement system according to Aspect 12 or 13, wherein the correlation is at least one of a formula using a linear model, a formula using a quadratic function model, a formula using a polynomial model, and a formula obtained with use of machine learning.
(Aspect 16)

The weight measurement system according to Aspect 1, further including a second obtaining section configured to obtain acceleration data of the carrying arm when the gripping part of the carrying arm which part is gripping the article moves three-dimensionally, the weight deriving section deriving the weight data indicating the weight of the article by processing the output signal and the acceleration data.
(Aspect 17)

The weight measurement system according to Aspect 16, wherein the output section outputs the weight data to a control device of the carrying arm.
(Aspect 18)

The weight measurement system according to Aspect 17, further including a trajectory changing section configured to refer to the weight data to change a trajectory along which the gripping part of the carrying arm moves, the output section outputting trajectory data indicating the trajectory after change to the control device of the carrying arm.
(Aspect 19)

The weight measurement system according to Aspect 18, wherein the first obtaining section further obtains the type of the article, and the trajectory changing section refers to the type of the article to change the trajectory along which the gripping part of the carrying arm moves.
(Aspect 20)

The weight measurement system according to Aspect 18, further including a determination section configured to determine whether or not the weight data satisfies a predetermined weight standard, the trajectory changing section changing the trajectory with reference to a determination result from the determination section.
(Aspect 21)

The weight measurement system according to Aspect 20, wherein the output section outputs, to a display device, at least one of the weight data, the trajectory after change, and the determination result from the determination section.
(Aspect 22)

An information processing device comprising:
a first obtaining section configured to obtain an output signal, when a gripping part of a carrying arm which part is gripping an article moves three-dimensionally, from a force sensor attached to the gripping part, the carrying arm carrying the article by gripping;
a weight deriving section configured to derive weight data indicating a weight of the article by processing the output signal; and
an output section configured to output the weight data to an external entity.
(Aspect 23)

The information processing device according to Aspect 22, further including a second obtaining section configured to obtain acceleration data of the carrying arm when the gripping part that is gripping the article moves three-dimensionally,
the weight deriving section deriving the weight data indicating the weight of the article by processing the output signal and the acceleration data.
(Aspect 24)

A weight measurement method comprising:
a first obtaining step of obtaining an output signal, when a gripping part of a carrying arm which part is gripping an article moves three-dimensionally, from a force sensor attached to the gripping part, the carrying arm carrying the article by gripping;
a weight deriving step of deriving weight data indicating a weight of the article by processing the output signal; and
an output step of outputting the weight data to an external entity.
(Aspect 25)

The weight measurement method according to Aspect 24, further including a second obtaining step of obtaining acceleration data of the carrying arm when the gripping part that is gripping the article moves three-dimensionally,
in the weight deriving step, the weight data indicating the weight of the article being derived by processing the output signal and the acceleration data.

The present invention is not limited to the embodiments, but can be altered by a skilled person in the art within the scope of the claims. The present invention also encompasses, in its technical scope, any embodiment derived by combining technical means disclosed in differing embodiments.

1. A weight measurement system comprising:
a force sensor attachable to a gripping part of a carrying arm carrying an article by gripping;
a first obtaining section configured to obtain an output signal from the force sensor when the gripping part that is gripping the article moves three-dimensionally;
a weight deriving section configured to derive weight data indicating a weight of the article by processing the output signal; and
an output section configured to output the weight data to an external entity.

2. The weight measurement system according to claim 1, wherein the weight deriving section derives the weight data by processing the output signal for a case where the gripping part is controlled to move along a predetermined trajectory.

3. The weight measurement system according to claim 1, wherein the weight deriving section derives the weight data by processing the output signal for a case where the gripping part is controlled to move with a predetermined acceleration.

4. The weight measurement system according to claim 2, wherein the weight deriving section derives the weight data with reference to a correlation set up in advance between an output signal from the force sensor for a case where the gripping part is controlled to move along a predetermined trajectory which signal is obtained when a specific article is carried and weight data corresponding to the output signal.

5. The weight measurement system according to claim 3, wherein the weight deriving section derives the weight data with reference to a correlation set up in advance between an output signal from the force sensor for a case where the gripping part is controlled to move with a predetermined acceleration which signal is obtained when a specific article is carried and weight data corresponding to the output signal.

6. The weight measurement system according to claim 1, further comprising a control signal obtaining section configured to obtain a control signal that controls the gripping part to move, the weight deriving section deriving the weight data by processing the output signal subsequent to a time point when the control signal has been obtained.

7. The weight measurement system according to claim 4, wherein the correlation is at least one of a formula using a linear model, a formula using a quadratic function model, a formula using a polynomial model, and a formula obtained with use of machine learning.

8. The weight measurement system according to claim 1, further comprising a second obtaining section configured to obtain acceleration data of the carrying arm when the gripping part of the carrying arm which part is gripping the article moves three-dimensionally,
the weight deriving section deriving the weight data indicating the weight of the article by processing the output signal and the acceleration data.

9. The weight measurement system according to claim 8, wherein the output section outputs the weight data to a control device of the carrying arm.

10. The weight measurement system according to claim 9, further comprising a trajectory changing section configured to refer to the weight data to change a trajectory along which the gripping part of the carrying arm moves,
the output section outputting trajectory data indicating the trajectory after change to the control device of the carrying arm.

11. The weight measurement system according to claim 10, wherein
the first obtaining section further obtains the type of the article, and
the trajectory changing section refers to the type of the article to change the trajectory along which the gripping part of the carrying arm moves.

12. The weight measurement system according to claim 10, further comprising a determination section configured to determine whether or not the weight data satisfies a predetermined weight standard,
the trajectory changing section changing the trajectory with reference to a determination result from the determination section.

13. The weight measurement system according to claim 12, wherein the output section outputs, to a display device, at least one of the weight data, the trajectory after change, and the determination result from the determination section.

14. An information processing device comprising:
a first obtaining section configured to obtain an output signal, when a gripping part of a carrying arm which part is gripping an article moves three-dimensionally, from a force sensor attached to the gripping part, the carrying arm carrying the article by gripping;
a weight deriving section configured to derive weight data indicating a weight of the article by processing the output signal; and
an output section configured to output the weight data to an external entity.

15. The information processing device according to claim 14, further comprising a second obtaining section configured to obtain acceleration data of the carrying arm when the gripping part that is gripping the article moves three-dimensionally,
the weight deriving section deriving the weight data indicating the weight of the article by processing the output signal and the acceleration data.

16. A weight measurement method comprising:
a first obtaining step of obtaining an output signal, when a gripping part of a carrying arm which part is gripping an article moves three-dimensionally, from a force sensor attached to the gripping part, the carrying arm carrying the article by gripping;
a weight deriving step of deriving weight data indicating a weight of the article by processing the output signal; and
an output step of outputting the weight data to an external entity.

17. The weight measurement method according to claim 16, further comprising a second obtaining step of obtaining acceleration data of the carrying arm when the gripping part that is gripping the article moves three-dimensionally,
in the weight deriving step, the weight data indicating the weight of the article being derived by processing the output signal and the acceleration data.
